(19) United States
(12) Patent Application Publication
(10) Pub. No.: US 2013/0067572 A1
(43) Pub. Date: Mar. 14, 2013

(54) SECURITY EVENT MONITORING DEVICE, METHOD, AND PROGRAM

(71) Applicant: Eiji Muramoto, Tokyo (JP)

(72) Inventor: Eiji Muramoto, Tokyo (JP)

(73) Assignee: NEC CORPORATION, Tokyo (JP)

(21) Appl. No.: 13/608,741

(22) Filed: Sep. 10, 2012

(30) Foreign Application Priority Data
Sep. 13, 2011 (JP) 2011-199776

(51) Int. Cl. G06F 21/00

(52) U.S. Cl. 726/22

(57) ABSTRACT

The security event monitoring device includes: a storage module which stores in advance a correlation rule; a log collection unit which receives each log from each monitoring target device; a correlation analysis unit which generates scenario candidates by associating each of the logs; a scenario candidate evaluation unit which calculates the importance degrees of each scenario candidate; and a result display unit which displays/outputs the scenario candidate of a high importance degree. The scenario candidate evaluation unit includes: a user association degree evaluation function which calculates user association degrees; an operation association degree evaluation function which calculates the operation association degrees; and a scenario candidate importance reevaluation function which recalculates the importance degrees of each of the scenario candidates by each user according to the user association degrees and the operation association degrees.

### CROSS-REFERENCE TO RELATED APPLICATION

This application is based upon and claims the benefit of priority from Japanese patent application No. 2011-199776, filed on Sep. 13, 2011, the disclosure of which is incorporated herein in its entirety by reference.

### BACKGROUND OF THE INVENTION

1. Field of the Invention

The present invention relates to a security event monitoring device, a method, and a program thereof. More specifically, the present invention relates to a security event monitoring device and the like for making it possible to highly accurately specify a user who is conducting an operation that causes a problem.

2. Description of the Related Art

At the present time where the computer networks have become the fundamentals of the basic tasks of those who are in charge of business, a vast amount of personal information and confidential information related to such tasks are handled on a local network. Naturally, it is required to be very cautious when handling the information so that the information is not leaked to the outside of the organization.

An action conducted on a computer network regarding the security of the network is referred to as a security event herein. For example, to take out a specific file (referred to as an important file hereinafter) containing confidential information, personal information, and the like to the outside of the organization without permission corresponds to the security event.

The security event monitoring device is a device which: monitors the network; when there is a specific security event being conducted, promptly detects that event; and specifies the person who conducted that action. Each device constituting the network includes a function which records an operation and the like executed for the device to an operation log (simply referred to as a log hereinafter) and transmits the log to the security event monitoring device. The security event monitoring device performs a correlation analysis on the logs received from a plurality of monitoring-target devices to detect that security event.

As the techniques regarding that, there are flowing techniques. Among those, Japanese Unexamined Patent Publication 2007-183911 (Patent Document 1) discloses a technique regarding an unlawful operation monitoring system which calculates a suspicious value for a target operation, and sets a higher suspicious value when an operation of a high suspicious value is repeatedly conducted. Japanese Unexamined Patent Publication 2009-080650 (Patent Document 2) discloses an operation support device which presents an appropriate operation guide by detecting the operation intention of a user from a series of the operations conducted by the user.

Japanese Unexamined Patent Publication 2009-217657 (Patent Document 3) discloses a correlation analysis device which, when a common intrinsic expression exists in log data of different systems, associates those to each other. Japanese Unexamined Patent Publication 2009-259064 (Patent Document 4) discloses an evaluation device which stores a specific operation as a scenario, and calculates an operation cost when that operation in advance is executed. Japanese Unexamined Patent Publication 2011-008558 (Patent Document 5) discloses a web application system which measures the required time when each operation registered in a pre-stored scenario is executed, as in the case of Patent Document 4.

U. H. G. R. D Nawarathna and S. R. Kodithuwakku: “A Fuzzy Role Based Access Control Model for Database Security”, Proceedings of the International Conference on Information and Automation, Dec. 15-18, 2005 (Non-Patent Document 1) discloses an access control method which expresses circumstances such as “necessity for a user to read and write a column” and “degree of hostility of a user”, for example, which can only be expressed ambiguously with linguistic variables of a fuzzy theory, and uses those as parameters.

Regarding the operations conducted on the monitoring target device and recorded on the log, all the users who have done the operations are not necessarily specified. More specifically, in a state where a plurality of users are simultaneously logging in and working with a common ID or a state where a user makes an access to a server via a relay device such as a proxy server (with a user ID replaced by the relay device), for example, it is difficult to specify the individual who has actually done the operation by using the ID.

Thus, when an operation whose operator cannot be specified is contained in the log, it is extremely difficult to detect the security event by the security event monitoring device. Therefore, even when there is an individual who repeatedly conducts actions that cause a serious problem for the security on the network, such actions cannot be detected.

The technique that can overcome such problem is not depicted in Patent Documents 1 to 5 and Non-Patent Document 1 described above. In the technique depicted in Patent Document 1, it is assumed that the users who have conducted the operations are specified for all the operations. Therefore, there is no consideration at all regarding the case where the operator cannot be specified.

The techniques depicted in Patent Documents 2 to 5 are not designed to detect the user who has conducted an unlawful operation in the first place. Further, there is no depiction regarding the content that can be diverted to such purpose. The technique depicted in Non-Patent Document 1 judges whether or not the detected operation violates the given policy. However, a calculation reflected on a judgment regarding whether or not the same user has done a series of operations is not executed therein. Therefore, it is not possible to acquire a technique capable of overcoming the above-described problem even when all the techniques depicted in Patent Documents 1 to 5 and Non-Patent Document 1 are combined.

### SUMMARY OF THE INVENTION

An exemplary object of the present invention is to provide a security event monitoring device, a method, and a program thereof capable of detecting a security event properly and further estimating the person who executed the operation when collected logs includes such operation whose operator cannot be specified.

In order to achieve the foregoing exemplary object, the security event monitoring device according to an exemplary aspect of the invention is a security event monitoring device which detects a specific operation from logs that are records of operations conducted on a plurality of monitoring target devices connected mutually on a same local network, and the security event monitoring device is characterized to include: a storage module which stores in advance a correlation rule that is applied when performing a correlation analysis on each of the logs: a log collection unit which receives each of the logs from each of the monitoring target devices; a correlation analysis unit which generates scenario candidates in which each of the logs is associated with each other by applying the correlation rule to each of the logs, and stores the scenario candidates to the storage module along with an importance degree of the scenario candidate given by the correlation rule; a scenario candidate evaluation unit which recalculates the importance degree for each of the scenario candidates; and a result display unit which displays/outputs the scenario candidate with the recalculated high importance degree, wherein the scenario candidate evaluation unit includes: a user association degree evaluation function which enumerates possible users who may have done each of the operations contained in each of the scenario candidates, and calculates user association degrees that are relevancies of each of the users for each of the operations; an operation association degree evaluation function which calculates operation association degrees that are relevancies between each of the operations of each of the scenario candidates; and a scenario candidate importance degree reevaluation function which recalculates the importance degrees of each of the scenario candidates by each of the users according to the user association degrees and the operation association degrees.

In order to achieve the foregoing exemplary object, the security event monitoring method according to another exemplary aspect of the invention is a security event monitoring method used for a security event monitoring device which detects a specific operation from logs that are records of operations conducted on a plurality of monitoring target devices connected mutually on a same local network. The method is characterized that: a log collection unit receives each of the logs from each of the monitoring target devices; a correlation analysis unit generates scenario candidates in which each of the logs is associated with each other by applying a correlation rule given in advance to each of the logs; the correlation analysis unit stores each of the scenario candidates to the storage module along with importance degrees of the scenario candidates given by the correlation rule; a user association degree evaluation function of a scenario candidate evaluation unit enumerates possible users who may have done each of the operations contained in each of the scenario candidates; the user association degree evaluation function calculates the user association degrees that are relevancies of each of the users for each of the operations; an operation association degree evaluation function of the scenario candidate evaluation unit calculates operation association degrees that are relevancies between each of the operations of each of the scenario candidates; a scenario candidate importance degree recalculation function of the scenario candidate evaluation unit recalculates the importance degrees of each of the scenario candidates by each of the users according to the user association degrees and the operation association degrees; and a result display unit displays/outputs the scenario candidate of the high importance degree.

In order to achieve the foregoing exemplary object, the security event monitoring program according to still another exemplary aspect of the invention is a security event monitoring program used in a security event monitoring device which detects a specific operation from logs that are records of operations conducted on a plurality of monitoring target devices connected mutually on a same local network. The program is characterized to cause a computer provided to the security event monitoring device to execute: a procedure for receiving each of the logs from each of the monitoring target devices; a procedure for generating scenario candidates in which each of the logs are associated by applying a correlation rule given in advance to each of the logs; a procedure for storing each of the scenario candidates along with the importance degrees of the scenario candidates given by the correlation rule; a procedure for enumerating possible users who may have done each of the operations contained in each of the scenario candidates; a procedure for calculating user association degrees that are relevancies of each of the users for each of the operations; a procedure for calculating operation association degrees that are relevancies between each of the operations of each of the scenario candidates; a procedure for recalculating importance degrees of each of the scenario candidates by each of the users according to the user association degrees and the operation association degrees; and a procedure for displaying/outputting the scenario candidate of the high importance degree.

As described above, the present invention is structured to calculate the user association degree that is the relevancy between each of the users who may have done each operation and the operation association degree that is the relevancy between each of the operations, and to calculate the importance degree of each scenario candidate for each user based thereupon regarding the scenario candidate generated by the correlation analysis. Therefore, it is possible to estimate who is the possible user, even when the operator is not being specified.

### BRIEF DESCRIPTION OF THE DRAWINGS

FIG. 1 is an explanatory chart showing a more detailed structure of a security event monitoring device shown in FIG. 2;

FIG. 2 is an explanatory chart showing the structure of a computer network containing the security event monitoring device according to a first exemplary embodiment of the present invention;

FIG. 3 is a flowchart showing actions of a correlation analysis unit, a scenario candidate evaluation unit, and a result display unit shown in FIG. 1;

FIG. 4 is an explanatory chart showing an example of stored contents of a correlation rule storage unit shown in FIG. 1;

FIG. 5 is an explanatory chart showing contents (steps S201 to 202 of FIG. 3) of the actions of a log collection unit and the correlation analysis unit shown in FIG. 1;

FIG. 6 is an explanatory chart showing contents (step S203 of FIG. 3) of the actions of a user association degree evaluation function shown in FIG. 1;

FIG. 7 is an explanatory chart showing contents (steps S203 to 204 of FIG. 3) of the actions of the user association degree evaluation function and an operation association degree evaluation function of a scenario candidate evaluation unit shown in FIG. 1;

FIG. 8 is an explanatory chart showing more details of the action example regarding the evaluation of the operation association degree done by the operation association degree evaluation function shown in FIG. 7;

FIG. 9 is an explanatory chart showing more details of the contents (step S205 of FIG. 3) of a scenario importance score recalculating action done by a scenario candidate importance degree reevaluation function shown in FIG. 1; and

FIG. 10 is an explanatory chart showing an example of a list of the scenario candidates of high importance degrees displayed by a result display unit shown in FIG. 1 on a screen of a display module (step S206 of FIG. 3).

### DETAILED DESCRIPTIONS OF THE PREFERRED EMBODIMENTS

### Exemplary Embodiment

Hereinafter, structures of an exemplary embodiment of the present invention will be described by referring to the accompanying drawings.

The basic contents of the exemplary embodiment will be described first, and more specific contents thereof will be described later.

A security event monitoring device 10 according to the exemplary embodiment is a security event monitoring device which detects a specific operation from logs that are records of operations conducted on a plurality of monitoring target devices 21 to 23 which are mutually connected on a same local network 25. The security event monitoring device 10 includes: a storage module 12 (a correlation rule storage unit 111) which stores in advance a correlation rule applied when performing a correlation analysis on each log; a log collection unit 101 which receives each log from each monitoring target device; a correlation analysis unit 103 which applies the correlation rule for each log to generate scenario candidates by associating each of the logs thereby, and stores those to a storage module (a scenario candidate storage unit 113) along with the importance degrees of the scenario candidates given by the correlation rule; a scenario candidate evaluation unit 104 which recalculates the importance degrees of each scenario candidate; and a result display unit 105 which displays/outputs the scenario candidate of a high importance degree. Further, the scenario candidate evaluation unit 104 includes: a user association degree evaluation function 104a which enumerates the possible users who may have done each operation contained in each scenario candidate, and calculates the user association degree that is the relevancy of each user with respect to each operation; an operation association degree evaluation function 104b which calculates the operation association degree that is the relevancy between each of the operations of each of the scenario candidates; and a scenario candidate importance reevaluation function 104c which recalculates the importance degree of each of the scenario candidates by each user according to the user association degree and the operation association degree.

Note here that the user association evaluation function 104a enumerates the users capable of conducting the operations for the monitoring target device during the time where the operations contained in each of the scenario candidates are done, and enumerates the users who are authorized to conduct the operations contained in each of the scenario candidates by inquiring to a directory service device (a directory server 24) connected externally.

Further, the operation association degree evaluation function 104b calculates the operation association degree from the similarity of the files as the targets of each operation based on the evaluation standard given in advance. As the evaluation standard of the similarity of the files mentioned herein, at least one selected from the name, size, pass name, hash value, and electronic signature of the file as the target of the respective operation is used.

Furthermore, the scenario candidate importance degree reevaluation function 104c recalculates the importance degree of each scenario candidate of each user by integrating the total value of products of the user relevancy decrees of each of the users corresponding to the scenario candidates and the importance degrees of each of the operations contained in each of the scenario candidates and the total value of the product of the operation association degrees between each of the operations contained in each of the scenario candidates, the importance degrees of the corresponding operations, and the importance degrees of each of the scenario candidates. Further, the result display unit 105 displays the user having a high user association degree for the scenario candidate along with the scenario candidate of a high importance degree.

With the above-described structures, the security event monitoring device 10 of the exemplary embodiment becomes capable of detecting the security event properly and estimating the user who has done the operation, even when the collected logs contain an operation whose operator cannot be specified.

This will be described in more details hereinafter.

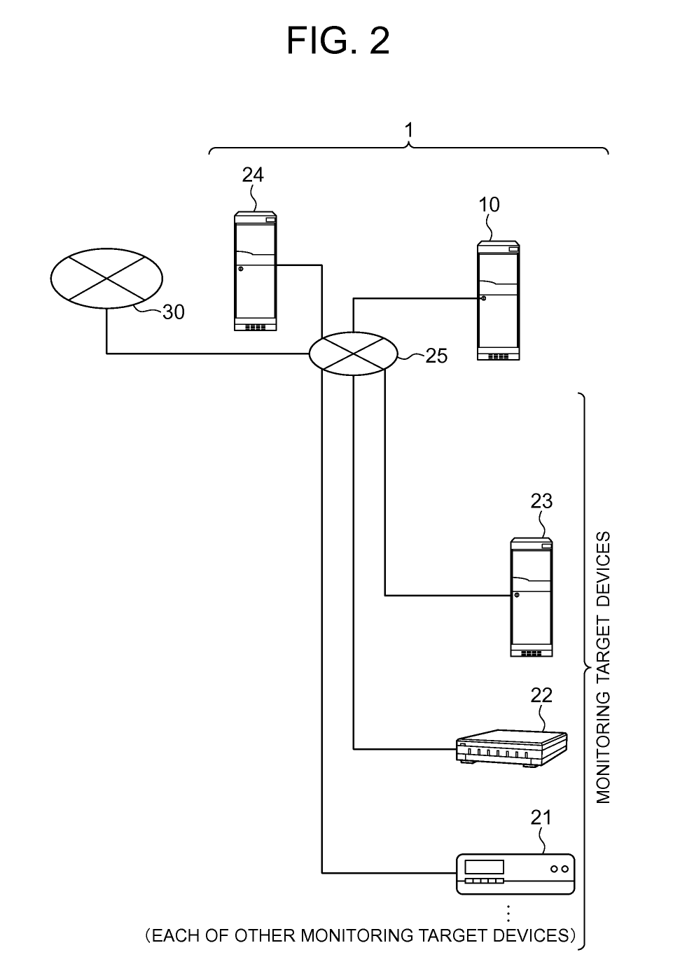

FIG. 2 is an explanatory chart showing the structure of a computer network 1 including the security event monitoring device 10 according to a first exemplary embodiment of the present invention. The computer network 1 is a computer network such as LAN (Local Area Network) or WAN (Wide Area Network) which can be connected to Internet 30, to which a plurality of devices such as a security device 21 (firewall, etc.), a network device 22 (a router, a switching hub, etc.), and a computer device 23 (a server, a personal computer, etc.) are connected mutually via a local network 25.

The security event monitoring device 10 is connected to the local network 25, and operates by having the security device 21, the network device 22, and the computer device 23 as the monitoring targets (hereinafter, “monitoring target device” is used as a general term for the security device 21, the network device 22, and the computer device 23). Further, the security event monitoring device 10 operates in cooperation with the directory server 24 that is another device connected to the local network 25. Details thereof will be described later.

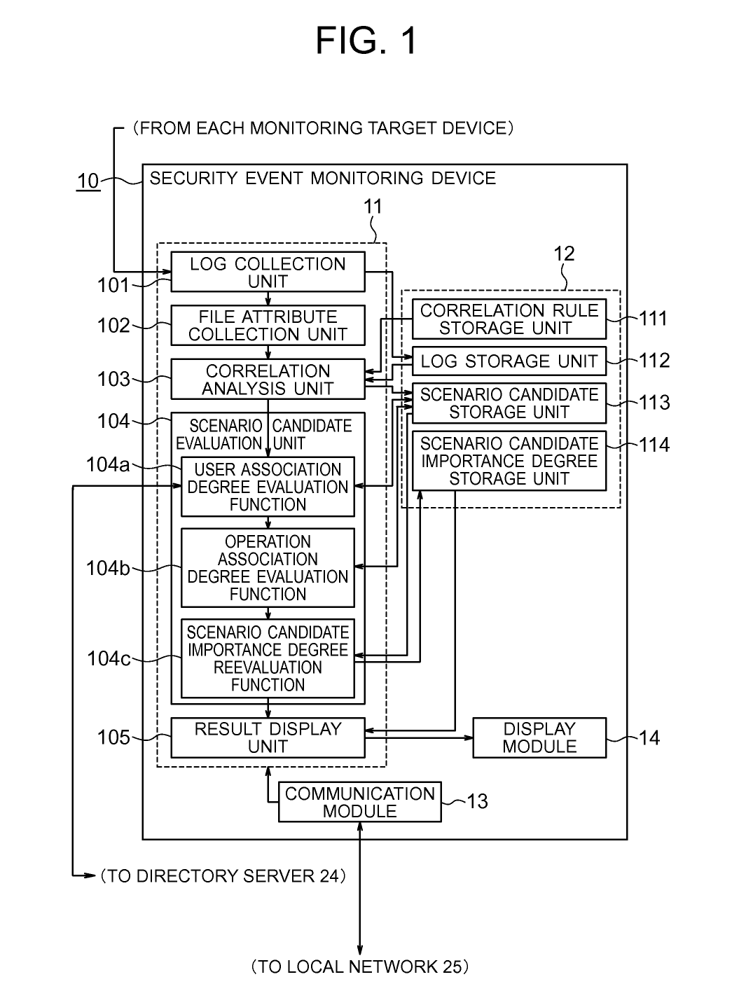

FIG. 1 is an explanatory chart showing a more detailed structure of the security event monitoring device 10 shown in FIG. 2. The security event monitoring device 10 includes the basic structures as a computer device. That is, the security event monitoring device 10 includes: a central processing unit (CPU) 11 which is the main body for executing computer programs; a storage module 12 for storing data; a communication module 13 for exchanging data with other devices via the local network 25; and a display module 14 for presenting processing results to the user.

The CPU 11 functions as the log collection unit 101, the file attribute collection unit 102, the correlation analysis unit 103, the scenario candidate evaluation unit 104, and the result display unit 105 to be described later by executing computer programs. The scenario candidate evaluation unit 104 includes: the user association evaluation function 104a, the operation association degree evaluation function 104b, and the scenario candidate importance reevaluation function 104c. Each of those units can be structured to be executed by separate computer devices, respectively.

In the meantime, storage regions such as the correlation rule storage unit 111, a log storage unit 112, the scenario candidate storage unit 113, and a scenario candidate importance degree storage unit 114 are provided to the storage module 12, and respective data are stored thereto in advance. Details thereof will also be described later.

### (Outline of Actions)

Hereinafter, outlines of the actions of each of the units of the security event monitoring device 10 described by referring to FIGS. 1 and 2 will be described. Each of the security device 21, the network device 22, and the computer device 23 records various events generated on the system as logs, and transmits those to the security event monitoring device 10. In the security event monitoring device 10, the log collection unit 101 receives and collects those logs, performs processing such as normalization and filtering thereon, gives those to the correlation analysis unit 103 as event data, and stores those to the log storage unit 112 further.

Regarding the event data received from the log collection unit 101, the correlation analysis unit 103 finds a pattern that matches the condition based on the rule defined in advance on the correlation rule storage unit 111. It is to be noted that the type of rule for detecting a series of complex operations is particularly referred to as a scenario, and those acquired by matching the event data to the scenario are referred to as scenario candidates.

The correlation analysis unit 103 evaluates the importance degrees of individual scenario candidates as scores by considering the importance degrees of the individual constituting events, the generated number or frequency of the events, the importance degree of a detected threat, the importance degree of the related information property, the vulnerability degree of the target of attack, and the like, and stores those to the scenario candidate storage unit 113 in combination. The scenario candidate evaluation unit 104 uses the user association evaluation function 104a to refer to the scenario candidates recorded on the scenario candidate storage unit 113 to enumerate the possible users who may have done each of the operations constituting the scenario candidates when those correspond to any of a plurality of following conditions.

(a) A case where the user can be uniquely specified by collating a plurality of logs such as logon logs, communicating logs, and the like by performing a correlation analysis
(b) A case where the users can be specified to a plurality of candidates by performing a correlation analysis
(c) A case where there remains a log with which an operation can be estimated to have been done latently during a corresponding time, even when the user (candidate) who has done the operation cannot be specified by performing a correlation analysis
(d) A case where there is no record of the above-described cases but the users who are authorized to execute the corresponding operation can be enumerated

Among those, the users are enumerated regarding the condition (c) by collating records of a local login to a terminal, authentication of VPN connection, going to work and going in/out of a room, previous request for performing a work related to the corresponding operation, and the like with the time of the operation among various kinds of logs collected by the log collection unit 101. Further, regarding the condition (d), the users that are authorized to conduct the operation are enumerated by inquiring to the directory server 24.

Further, the user association degree evaluation function 104a expands the scenario candidates by the enumerated users. Then, “100%÷the number of candidates” is calculated as “user narrow-down probability (user association degree), and it is additionally recorded to the scenario candidate storage unit 113.

Regarding the series of operations constituting each of the scenario candidates recorded on the scenario candidate storage unit 113, the operation association degree evaluation function 104b compares/evaluates the similarity of the files as the operation targets, and additionally records the similarity depth to the scenario candidate storage unit 113 as the unlawful use probability (=operation association degree).

Note here that the evaluation of the similarity of the files as the operation targets is executed by the operation association degree evaluation function 104b by making comparisons and the like of the pass names of the files, the signatures given to the files, the hash values of the files, the file sizes, the file names, and the like. The attributes of the files are collected by the file attribute collection unit 102 at a stage of collecting the logs by the log collection unit 101 or at a stage of collating the associated logs by the correlation analysis unit 103.

The scenario candidate importance degree reevaluation function 104c reevaluates the importance degree scores of each scenario candidate according to the user association degrees and the operation association degrees, and the importance degree scores calculated by the reevaluation are stored in the scenario candidate importance degree storage unit 114. Specifically, the importance degrees of the scenario candidates are corrected by Expression 1 mentioned later in which the number of the rule condition parts, the matching degrees with respect to the condition parts, the extent of the user association degrees, the extent of the operation association degrees, the extent of the user association degrees weighted by the operation importance degree scores, and the extent of the operation association degrees weighted by the operation importance degree scores are taken into consideration.

Among the scenario candidates stored in the scenario candidate storage unit 113, the result display unit 105 displays the scenario candidates whose scenario candidate importance degrees stored in the scenario candidate importance degree storage unit 114 are higher than a specific threshold value on the screen of the display module 14. At that time, a list of the scenario candidates is displayed by rearranging those in order from those with a higher importance degree to a lower degree in such a manner that those with the high importance degree in particular is displayed on the screen with highlight by changing the color, for example.

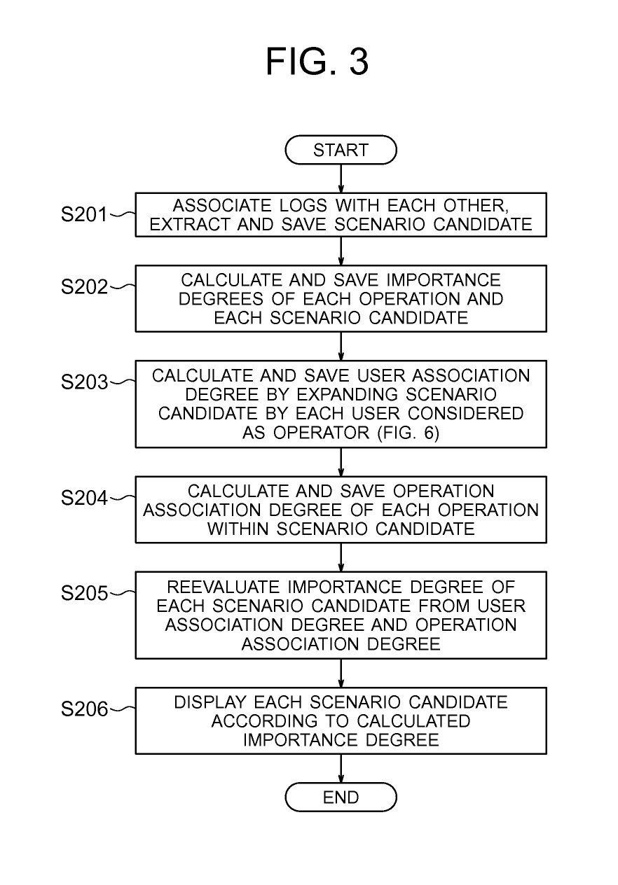

FIG. 3 is a flowchart showing the actions of the correlation analysis unit 103, the scenario candidate evaluation unit 104, and the result display unit 105 shown in FIG. 1. First, the correlation analysis unit 103 collates the logs received by the log collection unit 101 and stored in the log storage unit 112 with a user specifying rule 111a and a complex operation detecting rule 111b stored in the correlation rule storage unit 111 to associate each of the logs, and stores those to the scenario candidate storage unit 113 as “scenario candidates” (step S201).

Then, the correlation analysis unit 103 calculates the tentative importance degrees for each of the operations and the scenario candidates stored as the scenario candidates, and also stores those to the scenario candidate storage unit 113 (step S202). Specific actions for calculating the importance degrees will be described later.

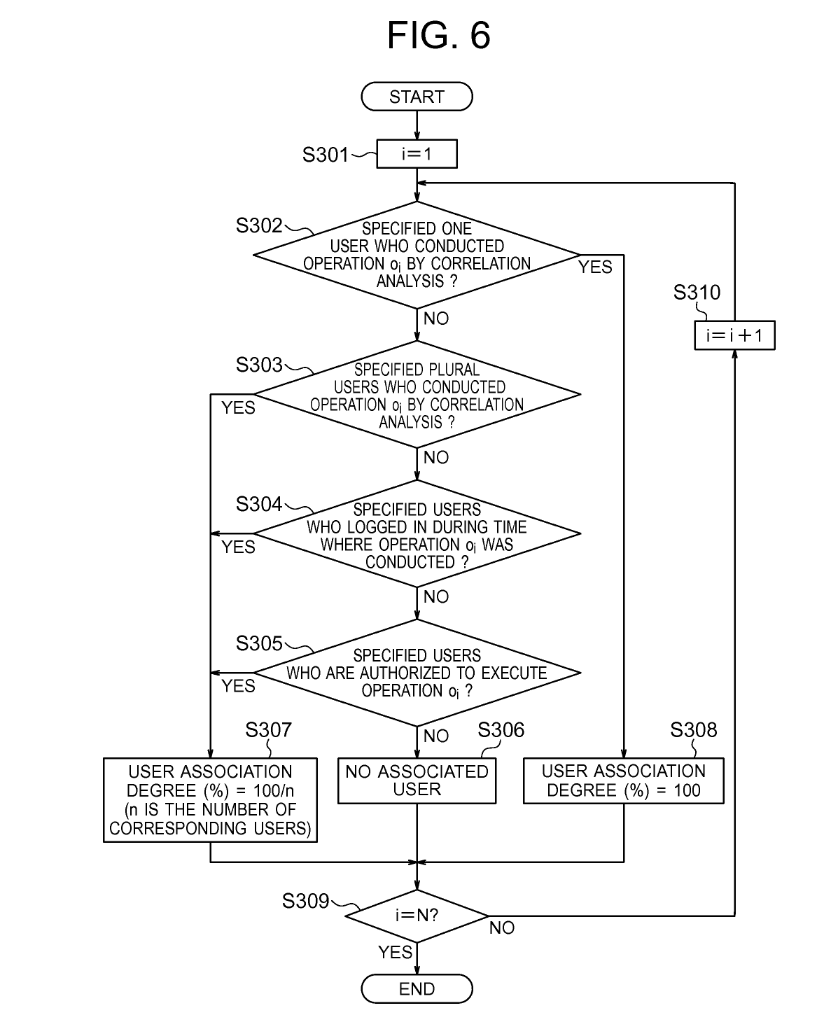

Then, the user association degree evaluation function 104a of the scenario candidate evaluation unit 104 enumerates the possible users who may have done each operation by referring to the scenario candidates stored in the scenario candidate storage unit 113 by the correlation analysis unit 103, calculates the user association degrees for each of the operations, expands the scenario candidates for each of the possible users, and additionally stores the result thereof to the scenario candidate storage unit 113 (step S203, FIG. 6 to be described later).

Upon that, the operation association degree evaluation function 104b of the scenario candidate evaluation unit 104 calculates the operation association degrees showing the depth of the association between each of the operations based on the evaluation standard given in advance, and additionally stores the result thereof to the scenario candidate storage unit 113 further (step S204).

Then, the scenario candidate importance degree reevaluation function 104c of the scenario candidate evaluation unit 104 reevaluates the importance degree scores of each of the scenario candidates by a following expression by utilizing the user association degrees and the operation association degrees calculated heretofore, and stores the calculated importance degree scores to the scenario candidate importance degree storage unit 114 (step S205).

At last, the result display unit 105 displays the scenario candidates stored in the scenario candidate storage unit 113 according to the scenario candidate importance degrees stored in the scenario candidate importance degree storage unit 114 on the screen of the display module 14 (step S206). More specific contents of the actions of the steps S203 to 205 will also be described later.

### (More Specific Examples of Actions)

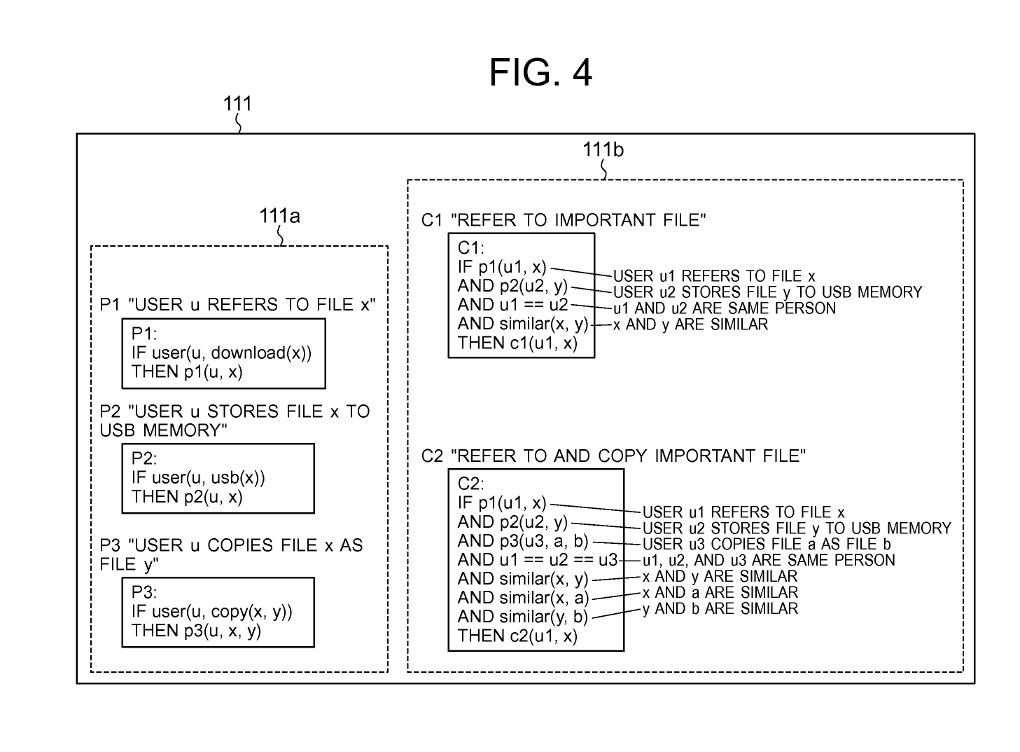

Hereinafter, more specific examples of the actions of the security event monitoring device 10 described by referring to FIGS. 1 to 3 are presented. FIG. 4 is an explanatory chart showing an example of the storage contents of the correlation rule storage unit 111 shown in FIG. 1. The user specifying rule 111a and the complex operation detecting rule 111b are stored in the correlation rule storage unit 111.

In this Specification, extremely simplified logs and rules are shown as a way of examples for showing the concept of the present invention plainly. In actual security event monitoring, the user who has done a specific operation is detected by collating a great number of logs received from a great number of monitoring target devices while applying complicated rules thereto.

Out of those, three rules of rules P1 to P3 are shown in the example of FIG. 4 as the user specifying rule 111a. Written in the first row of the rule P1 is that the rule name is “P1”, and written in the second to third rows is that if a log indicating that “a specific user u refers to a specific file (important file) x” is detected, it is defined as “p1(u, x)”.

Similarly, written in the rule P2 is that if a log indicating that “a specific user u stores a specific file (important file) x to a USB memory” is detected, it is defined as “p2(u, x)”. Written in the rule P3 is that if a log indicating that “a specific user u copies a specific file (important file) x to a file y” is detected, it is defined as “p3(u, x, y)”.

Two rules of C1 and C2 are shown in the example of FIG. 4 as the complex operation detecting rule 111b. Those rules C1 and C2 are also referred to as scenarios herein.

Written in the first row of the rule C1 is the rule name “C1”. The second to third rows show a case where “user u1 refers to a specific file x (P1 of the user specifying rule 111a) and user u2 stores a specific file y to a USB memory (P2 of the user specifying rule 111a)”, and fourth to fifth rows show a case where “user u1 and user u2 are the same, and the files x and y are similar”. It is also written that a case corresponding to all of the cases written in the second to fifth rows is defined as c1(u1, x).

Similarly, written in the first row of the rule C2 is the rule name “C2”. The second to fourth rows show a case where “user u1 refers to a specific file x (P1 of the user specifying rule 111a), user u2 stores a specific file y to a USB memory (P2 of the user specifying rule 111a), and user u3 copies a specific file a to a file b (P3 of the user specifying rule 111a)”, fifth to eighth rows show a case where “all the user u1, user u2, and user u3 are the same, and all the files x, y, a, and b are similar”. It is also written that a case corresponding to all of the cases written in the second to eighth rows is defined as c2(u1, x).

Regarding the complex operation detecting rule 111b, scenario names characterizing each of the complex operations are given in advance, e.g., a file name “take out important file” is given to the rule C1, and a file name “copy and take out important file” is given to the rule C2.

For detecting being “similar”, it is judged as “similar” when there is a match found therebetween by comparing the information such as the pass names, file sizes, file names, electronic signatures, and hash values of the files as the targets of the respective operations, and judged as “not similar” if not.

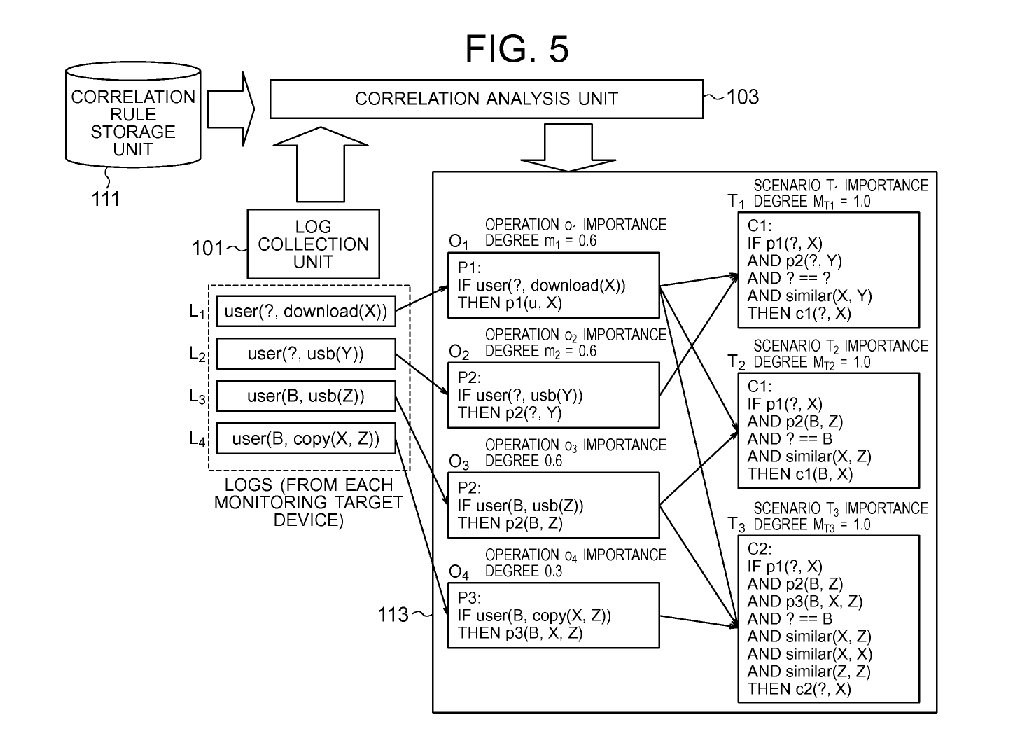

FIG. 5 is an explanatory chart showing contents of the actions of the log collection unit 101 and the correlation analysis unit 103 shown in FIG. 1 (steps S201 to 202 of FIG. 3). FIG. 5 shows an example of actions of a case where the user specifying rule 111a and the complex operation detecting rule 111b shown in FIG. 4 are stored in advance to the correlation rule storage unit 111. The log collection unit 101 receives logs L1 to L4 from each of the monitoring target devices, and gives those to the correlation analysis unit 103 and stores those in the log storage unit 112. Under the current circumstances, it is necessary to perform a correlation analysis by collating a great number of logs received from a plurality of monitoring target devices for detecting a single event. However, it is to be noted that simplified logs that have undergone the process up to the correlation analysis are also shown as the example in order to show the concept of the present invention plainly.

The log L1 indicates that “unspecified user has downloaded the file X”. Note here that “?” indicates that “user who has done the operation cannot be specified even after executing a correlation analysis or the like”. Similarly, the log L2 indicates that “unspecified user B has stored the file Y to the USB memory”. The log L3 indicates that “unspecified user B has stored file Z to USB memory”, and the log L4 indicates that “unspecified user B copies file X to file Z”. The correlation analysis unit 103 collates the user specifying rule 111a and the complex operation detecting rule 111b stored in the correlation rule storage unit 111 with the logs L1 to L4 to associate each of the logs with each other, and stores those to the scenario candidate storage unit 113 as the “scenario candidates” (step S201 of FIG. 3).

In the example shown in FIGS. 4 and 5, the correlation analysis unit 103 detects the log L1 based on the rule P1 and defines it as an operation o1. Further, the correlation analysis unit 103 detects the log L2 based on the rule P2 and defines it as an operation o2. Furthermore, the correlation analysis unit 103 detects a combination of the operation o1 and the operation o2 as a series of operations based on the rule c1, and stores it to the scenario candidate storage unit 113 as a scenario candidate T1. Note here that a variable u of the rule P1 is not determined since the user who has done the operation o1 is not specified from the log in that case, the user that has not been specified is defined as “?”, and then the action thereafter is continued.

Similarly, the correlation analysis unit 103 detects the log L3 based on the rule P2 and defines it as an operation o3. Further, the correlation analysis unit 103 detects the log L4 based on the rule P3 and defines it as an operation o4. Furthermore, the correlation analysis unit 103 detects a combination of the operation o1 and the operation o3 as a series of operations based on the rule C1, and stores it to the scenario candidate storage unit 113 as a scenario candidate T2. Moreover, the correlation analysis unit 103 detects a combination of the operations o2, o3, and o4 as a series of operations based on the rule C2, and stores it to the scenario candidate storage unit 113 as a scenario candidate T3.

The correlation analysis unit 103 further evaluates the importance degree score mi of the operation o1 and the importance degree score MTj of the scenario candidate Tj, and stores those to the scenario candidate storage unit 113 (step S202 of FIG. 3). Each of the correlation rules and the rules calculated based on the importance degrees of the threats associated with the events that match the correlation rules, the importance degrees of the information assets, and the degree of the vulnerability of the attack target are defined in advance on the correlation rule storage unit 111 by the user, and the importance degree score mi of the operation oi is calculated based thereupon. The importance degree score MTj of the scenario candidate Tj is calculated by executing the processing of the correlation analysis unit 103, and reevaluated by executing the processing to be described later.

In the example shown in FIG. 5, the respective importance degree scores m1 to m4 of the operations o1 to o4 are defined in advance as 0.6, 0.6, 0.6, and 0.3 by the user on the correlation rule storage unit 111. The importance degree scores MT1 to MT3 of the scenario candidates T1 to T3 are defined herein as 1.0, 1.0, and 1.0 for explanations. The processing executed by the correlation analysis unit 103 described heretofore is a well-known technique that is also depicted in Patent Document 1 mentioned above, and it is a technique that is a premise of the present invention.

FIG. 6 is a flowchart showing actions of the user association degree evaluation function 104a (step S203 of FIG. 3) shown in FIG. 1. The user association degree evaluation function 104a enumerates the possible users who may have done each of the operations by a plurality of methods through referring to the scenario candidates stored in the scenario candidate storage unit 113 by the correlation analysis unit 103.

The user association degree evaluation function 104a upon starting the action defines the initial value of the variable i as “1” (steps S301), and first judges whether or not the user who has done the operation can be specified as one user regarding the operation oi by the correlation analysis unit 103 (step S302). If the user can be specified as one (YES in step S302), the user association degree of the operation oi is defined as 100% (step S308). Then, the action is advanced to the processing of step S309.

When the correlation analysis unit 103 cannot specify the single user who has done the operation oi (NO in step S303), the user association degree evaluation function 104a judges whether or not the possible users are narrowed down to a plurality of users by the correlation analysis (step S303). If so (YES in step S303), the user association degree of the operation oi is defined as (100/n) % provided that the number of possible users is “n” (step s307). Then, the action is advanced to the processing of step S309.

When the correlation analysis unit 103 cannot specify the user who has done the operation oi at all (NO in step S303), the user association degree evaluation function 104a refers to the logs in the terminal login record collected by the log collection unit 101 to judge whether or not the users who logged in to the terminal capable of conducting the operation at the time when the operation oi was conducted can be specified (step S304). If judged as specified (YES in step S303), the user association degree of the operation oi is defined as (100/n) % provided that the number of possible users is “n” (step s307). Then, the action is advanced to the processing of step S309.

When the user who has done the operation oi cannot be specified at all even by referring to the logs of the terminal login record (NO in step S304), the user association degree evaluation function 104a makes an inquiry to the directory server 24 regarding who are the user authorized to conduct the operation oi (step S305).

When the authorized user can be specified by the inquiry (YES in step S305), the user association degree of the operation oi is defined as (100/n) % provided that the number of possible users is “n” (step s307). Then, the action is advanced to the processing of step S309. When the authorized user cannot be specified (NO in step S305), it is judged that there is no associated user (step S306). Then, the action is advanced to the processing of step S309.

Note here that the processing shown in steps S303 to 305 may extract the possible user who may have done the operation through making a judgment comprehensively by additionally considering the execution authority given to each user, alibi information acquired from the terminal login record or the like (information regarding the users who are not logging in at the time) and the like acquired by making an inquiry to the directory server 24.

Then, the user association degree evaluation function 104a judges whether or not “i” has reached the total number “N” of the operations oi stored in the scenario candidate storage unit 113 (step S309). When judged as reached, the user association degree evaluation function 104a ends the processing, and the action is advanced to the processing by the operation association degree evaluation function 104b. When judged as not reached, the value of i is incremented by one (step S310), and the processing is repeated from step S302.

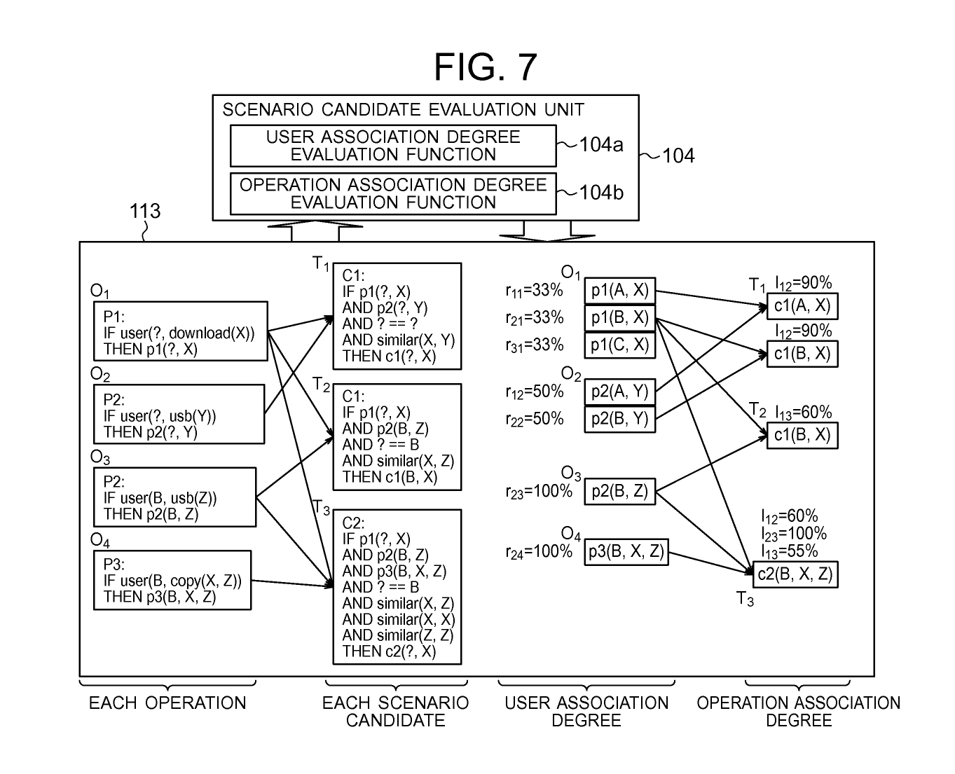

FIG. 7 is an explanatory chart showing the contents of the actions (steps S203 to 204 of FIG. 3) of the user association degree evaluation function 104a and the operation association degree evaluation function 104b of the scenario candidate evaluation unit 104 shown in FIG. 1. FIG. 7 shows the result of executing the actions described in the flowchart of FIG. 6 for the scenario candidates T1 to T3 that are stored in the scenario candidate storage unit 113 shown in FIG. 4. In this example, the correlation analysis unit 103 cannot specify the single or a plurality of users who may have done the operation oi (NO in both steps of S302 and 303 in FIG. 6). However, it is found that three users A to C were logging in to the terminal capable of conducting the operation o1 at the time when the operation o1 is executed (YES in step S304 of FIG. 6). Therefore, it is possible to acquire a result that each of the user association degrees r11, r11, and r11 of the users A to C as the probability for the users A to C to conduct the operation o1 is “100%÷3=33%” that is acquired by dividing 100% by the number of possible users “3” (step S307 of FIG. 6).

The user association degree evaluation function 104a expands each of the plurality of users A to C enumerated by the above-described actions by applying those to the scenario candidates T1 to T3 (step S203 of FIG. 3). For example, the operation o1 is expanded into three kinds such as p1(A, X), p1(B, X), and p1(C, X) since the three users A to C are enumerated as the candidates, and each of the user association degrees r11, r11 and r11 is calculated as 33%.

Similarly, the operation o2 is expanded into two kinds such as p2(A, Y) and p2(B, Y) since the two users A and B are enumerated as the candidates, and each of the user association degrees r22, and r22 is calculated as 50%. Regarding the operations o3 and o4, the operators thereof are specified as the user B as described above. Thus, acquired therefrom are p2(B, Z) and p3(B, X, Z), respectively, and the user association degrees r23 and r24 are both 100%.

The scenario candidate T1 is constituted with a combination of the operations o1 and o2 as described above. Those who can conduct both of the operations o1 and o2 are the users A and B (the user C may have done the operation o1 but not the operation o2). Thus, it is expanded into two kinds such as c1(A, X) and c1(B, X).

Similarly, the scenario candidate T2 is constituted with a combination of the operations o1 and o3. Further, the scenario candidate T3 is constituted with a combination of the operations o1, o3, and o4. Regarding the operations o3 and o4, the operators thereof are specified as the user B as described above. Thus, the scenario candidates T2 and T3 are both expanded only into the user B and expanded into one kind such as c1(B, X) and c2(B, X, Z), respectively. The user association degree evaluation function 104a stores the results of the above-described processing to the scenario candidate storage unit 113.

Then, the operation association degree evaluation function 104b calculates the operation association degree 1 pq that is the depth of the association between each of the operations p and q regarding a series of operations constituting each scenario candidate stored by the above actions (step S204 of FIG. 3). First, the file attribute collection unit 102 calculates or collects the information such as the pass names of the files as the targets of each of the operations, sizes of the files, names of the files, electronic signatures, and hash values at the point where the log collection unit 101 collects the logs or before the time of the point where the correlation analysis unit 103 performs pattern matching by a similar ( ) function described above.

The operation association degree evaluation function 104b calculates each of the operation association degrees based on the evaluation standard given in advance by using the information collected by the file attribute collection unit 102. For example, the evaluation standard is the values given in advance such as the operation association degree=100% when the operations are for the files of a same signature or under a same pass name on the machine, the operation association degree=90% when the operations are for the files of a same hash value, the operation association degree=60% when the operations are for the files of a same file size, and the operation association degree=55% when the operations are for the files under a same file name.

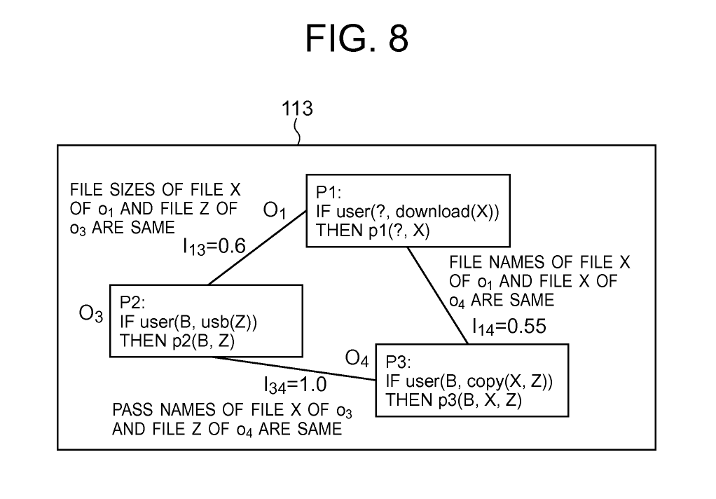

FIG. 8 is an explanatory chart showing more details of the example of the actions for evaluating the operation association degrees executed by the operation association degree evaluation function 104b shown in FIG. 7. FIG. 8 shows a case of calculating the operation association degrees between each of the operations o1, o3, and o4 which constitute the scenario candidate T3 shown in FIG. 4 and FIG. 7.

The file X of the operation o1 and the file Z of the operation o3 are similar (similar (X, Z)) in the scenario candidate T3. However, considering that it is because the file sizes thereof are the same, the operation association degree 113 between the operation o1 and the operation o3 is 60%. Similarly, regarding the file Z of the operation o3 and the file Z of the operation 4, the pass names are the same. Thus, the operation association degree 134 between the operation o3 and the operation o4 is 100%. Further, the file names are the same regarding the file X of the operation o1 and the file X of the operation o4, so that the operation association degree 114 between the operation o1 and the operation o4 is 55%.

Furthermore, similarly, the file X of the operation o1 and the file Y of the operation o2 have a same hash value regarding c1(A, X) of the user A in the scenario candidate T1. Thus, the operation association degree 112 between the operation o1 and the operation o2 is 90%. Regarding c1(B, X) of the user B, the operation association degree 112 between the operation o1 and the operation o2 of the user B also becomes 90%.

Further, regarding the file X of the operation o1 and the file Z of the operation o3 in the scenario candidate T2, the file sizes are the same. Thus, the operation association degree 113 between the operation o1 and the operation o3 is 60%. The operation association degree evaluation function 104b stores the above-described calculation results to the scenario candidate storage unit 113 as shown in FIG. 7.

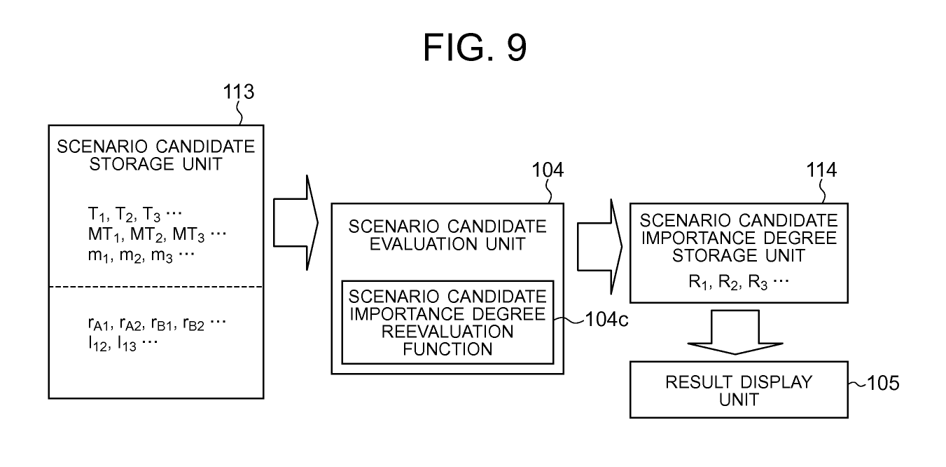

FIG. 9 is an explanatory chart showing more details of the contents of a scenario importance degree score recalculation action (step S205 of FIG. 3) executed by the scenario candidate importance reevaluation function 104c shown in FIG. 1. Regarding the scenario candidate Tx={ui, ok1, ok2, - - -, okn} by the user ui constituted with n-pieces of operations stored in the scenario candidate storage unit 113, the scenario candidate importance degree reevaluation function 104c recalculates the scenario importance degree scores MTi by a formula shown in following Expression 1, and it is defined as RTxi. The scenario candidate importance degree reevaluation function 104c performs the calculation on the scenario candidate Tx and all the users ui corresponding thereto. The users u1, u2, and u3 correspond to each of the users A, B, and C.

Note here that “n” is the total number of operations contained in each scenario candidate Tx, ui εU (U is a set of the entire users), ok1, ok2, - - -, oknεO (O is a set of the entire operations), “mj” is the importance degree score of the operation oj calculated by the processing of the correlation analysis unit 103 shown in FIG. 5 and defined as 1≧mj≧0, “rij” is the association degree between the user ui and the operation oj calculated by the processing of the user association degree evaluation function 104a shown in FIG. 7 and defined as 1≧rij≧0, “1 pq” is the association degree between the operations op and oq calculated by the processing of the operation association degree evaluation function 104b shown in FIG. 7 and defined as 1≧1 pq≧0.

$${R}_{{T}_{x} i} = \frac{1}{n} {\sum }_{j = 1}^{n} {r}_{{ik}_{j}} {m}_{{k}_{j}} \times \frac{\sqrt{{}_{n}^{ }{C}{}_{2}^{ }}}{{}_{n}^{ }{C}{}_{2}^{ }} ( {\sum }_{{p < q}_{{o}_{p} , {o}_{q} ∈ {T}_{i}}}^{n } {l}_{pq} {m}_{p} {m}_{q} \times {M}_{{T}_{x}} ) \qquad ( Expression 1 )$$

By using the formula, the importance degree of each scenario candidate is reevaluated in accordance with the number of rule condition part (√ₙC₂ part), the matching degree of the condition part (Σl_{pq}/ₙC₂ part), the overall user association degree (1/nτrᵢₖⱼ part), the importance degree score (rᵢₖⱼmₖⱼ part) of the operation the user actually has done (i.e., the operation of high user association degree). Further, the weight of the operation association degree is reevaluated in accordance with the importance degree score (l_{pq}mₚm_{q} part). The scenario candidate importance degree reevaluation function 104c stores the reevaluated scenario importance degree scores RTi calculated by the formula to the scenario candidate importance degree storage unit 114.

When the formula is applied to the case shown in FIGS. 4, 7, and 8, the reevaluated scenario importance degree score RT11 of the scenario candidate T1 of the user A can be calculated as about 8.1% as in following Expression 2 since n=2, k1=1, and k2=2. For the user B, as in following Expression 3, the reevaluated scenario importance degree score RT12 of the scenario candidate T1 can also be calculated as about 8.1%. The reevaluated scenario importance degree score for the user C is not calculated, since the user C does not correspond to the scenario candidate T1.

$$\begin{matrix}{R}_{{T}_{1} 1} = \frac{1}{2} ( {r}_{11} {m}_{1} + {r}_{12} {m}_{2} ) \times \frac{\sqrt{{}_{2}^{ }{C}{}_{2}^{ }}}{{}_{2}^{ }{C}{}_{2}^{ }} ( {l}_{12} {m}_{1} {m}_{2} \times {M}_{{T}_{1}} ) = \frac{1}{2} ( 0.33 \times 0.6 + 0.5 \times 0.6 ) \times \frac{1}{1} ( 0.9 \times 0.6 \times 0.6 \times 1 ) \approx 0.0807 & ( Expression 2 ) \\ {R}_{{T}_{1} 2} = \frac{1}{2} ( {r}_{21} {m}_{1} + {r}_{22} {m}_{2} ) \times \frac{\sqrt{{}_{2}^{ }{C}{}_{2}^{ }}}{{}_{2}^{ }{C}{}_{2}^{ }} ( {l}_{12} {m}_{1} {m}_{2} \times {M}_{{T}_{1}} ) = \frac{1}{2} ( 0.33 \times 0.6 + 0.5 \times 0.6 ) \times \frac{1}{1} ( 0.9 \times 0.6 \times 0.6 \times 1 ) \approx 0.0807 & ( Expression 3 )\end{matrix}$$

The reevaluated scenario importance degree score RT2 of the scenario candidate T2 of the user B can be calculated as about 8.6% as in following Expression 4 since n=2, k1=1, and k2=3. For the users A and C, the reevaluated scenario importance degree score is not calculated, since the users A and C do to correspond to the scenario candidate T2.

$${R}_{{T}_{2} 2} = \frac{1}{2} ( {r}_{21} {m}_{1} + {r}_{23} {m}_{3} ) \times \frac{\sqrt{{}_{2}^{ }{C}{}_{2}^{ }}}{{}_{2}^{ }{C}{}_{2}^{ }} ( {l}_{13} {m}_{1} {m}_{3} \times {M}_{{T}_{2}} ) = \frac{1}{2} ( 0.33 \times 0.6 + 1 \times 0.6 ) \times \frac{1}{1} ( 0.6 \times 0.6 \times 0.6 \times 1 ) \approx 0.0861 \qquad ( Expression 4 )$$

Further, the reevaluated scenario importance degree score RT3 of the scenario candidate T3 of the user B can be calculated as about 8.6% as in following Expression 5 since n=3, k1=1, k2=3, and k3=4. For the users A and C, the reevaluated scenario importance degree score is not calculated, since the users A and C do to correspond to the scenario candidate T3.

$${R}_{{T}_{3} 2} = \frac{1}{3} ( {r}_{21} {m}_{1} + {r}_{23} {m}_{3} + {r}_{24} {m}_{4} ) \times \frac{\sqrt{{}_{3}^{ }{C}{}_{2}^{ }}}{{}_{3}^{ }{C}{}_{2}^{ }} ( ( {l}_{13} {m}_{1} {m}_{3} + {l}_{14} {m}_{1} {m}_{4} + {l}_{34} {m}_{3} {m}_{4} ) \times {M}_{{T}_{3}} ) = \frac{1}{3} ( 0.33 \times 0.6 + 1 \times 0.6 + 1 \times 0.3 ) \times \frac{\sqrt{3}}{3} ( ( 0.6 \times 0.6 \times 0.6 + 0.55 \times 0.6 \times 0.3 + 1 \times 0.6 \times 0.3 ) \times 1 ) \approx 0.180 \qquad ( Expression 5 )$$

As described above, while the values 1.0, 1.0, 1.0 are assumed, respectively, for the importance degree scores MT1 to MT3 of each of the scenario candidates T1 to T3 in the example shown in FIG. 5, the actual actions of each user are to be reflected upon the reevaluated scenario candidate importance degree scores RT1 to RT3 calculated by the processing of the scenario candidate importance degree reevaluation function 104c. Particularly, even for a state where it is not possible to specify the user who has done the operation from the logs, the calculated scenario importance degree score becomes high when it is highly possible that the same user has done a series of operations.

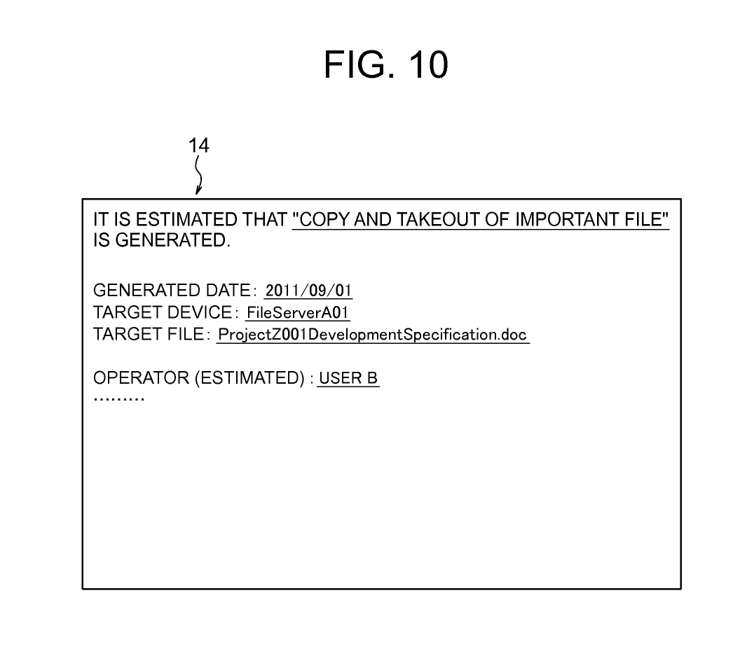

FIG. 10 is an explanatory chart showing an example of a list of the scenario candidates with a high importance degree to be displayed on the screen of the display module 14 by the result display unit 105 shown in FIG. 1 (step S206 of FIG. 3). Among the scenario candidates stored in the scenario candidate storage unit 113, the result display unit 105 displays those having the scenario candidate importance degrees stored in the scenario candidate importance degree storage unit 114 higher than a specific threshold value on the screen of the display module 14.

At that time, the result display unit 105 displays scenario names corresponding to each of the scenario candidates (e.g., names given to each of the complex operation detecting rules 111b such as “take out of important file”) as a list in which the scenario candidates are rearranged in order from those with a higher importance degree to a lower degree in such a manner that those with the high importance degree in particular is displayed on the screen with highlight by changing the color, for example. Further, the user who actually has done the operation shown in the scenario candidate or the user highly possible to have done the operation is displayed by being annexed to the scenario candidate.

In the case shown in FIG. 10, a threshold value “10%” is set in advance, and only the reevaluated scenario importance degree score RT23 of the scenario candidate T3 of the user B takes the value of 18.0% that exceeds the threshold value. Therefore, information such as the fact that it is estimated that the scenario name “copy and take out the important file” given to the scenario C2 as the base of the scenario candidate T3 is generated, the generated time thereof, the name of the monitoring target device, the target file name, and the name of the user (user B) that is estimated to have executed the operation is displayed on the display module 14.

### (Overall Actions of Exemplary Embodiment)

Next, overall actions of the above-described exemplary embodiment will be described.

The security event monitoring method according to the exemplary embodiment is used for the security event monitoring device which detects a specific operation from logs that are records of operations conducted on a plurality of monitoring target devices connected mutually on a same local network, wherein: a log collection unit receives each of the logs from each of the monitoring target devices; a correlation analysis unit generates scenario candidates in which each of the logs is associated with each other by applying correlation rules given in advance to each of the logs, and stores each of the scenario candidates to the storage module along with importance degrees of the scenario candidates given by the correlation rule (FIG. 3: steps S201 to 202); a user association degree evaluation function of a scenario candidate evaluation unit enumerates the possible users who may have done each of the operations contained in each of the scenario candidates, and calculates user association degrees that are relevancies of each of the users for each of the operations (FIG. 3: step S203); an operation association degree evaluation function of the scenario candidate evaluation unit calculates operation association degrees that are relevancies between each of the operations of each of the scenario candidates (FIG. 3: step S204); a scenario candidate importance degree recalculation function of the scenario candidate evaluation unit recalculates importance degrees of each of the scenario candidates by each of the users according to the user association degrees and the operation association degrees (FIG. 3: step S205); and a result display unit displays/outputs the scenario candidate of the high importance degree (FIG. 3: step S206).

Note here that each of the above-described action steps may be put into a program to be executable by a computer and have it executed by the security event monitoring device 10 which directly executes each of the above-described steps. The program may be recorded on a non-transitory recording medium such as a DVD, a CD, or a flash memory. In that case, the program is read out from the recording medium and executed by the computer.

The exemplary embodiment can provide the following effects by such actions.

In the exemplary embodiment, the importance degrees of each of the scenario candidates are calculated for each user by evaluating the possibility of conducting a series of operations by the same user based on the user association degrees, i.e., the probability of narrowing down of the user candidates, and the operation association degrees, i.e., the probability of the unlawful use of the information asset operated unlawfully. Therefore, even when a specific user repeats the operations capable of causing a problem in terms of the security for an important file, it is possible to detect the operation accurately and further to estimate the user with a high probability.

As an exemplary advantage according to the invention, this makes it possible to provide the security event monitoring device, the method, and the program thereof capable of detecting a security event properly and further estimating the person who executed the operation when the collected logs contain such operation whose operator cannot be specified.

While the present invention has been described by referring to the specific exemplary embodiment shown in the accompanying drawings, the present invention is not limited only to the exemplary embodiment shown in the drawings. It is to be noted that any known structures can be employed, as long as the effect of the present invention can be achieved therewith.

The new technical contents of the exemplary embodiment described above can be summarized as follows. While a part of or the entire part of the exemplary embodiment can be summarized as follows as a new technique, the present invention is not necessarily limited to those.

### (Supplementary Note 1)

A security event monitoring device which detects a specific operation from logs that are records of operations conducted on a plurality of monitoring target devices connected mutually on a same local network, and the security event monitoring device includes: a storage module which stores in advance a correlation rule that is applied when performing a correlation analysis on each of the logs: a log collection unit which receives each of the logs from each of the monitoring target devices; a correlation analysis unit which generates scenario candidates in which each of the logs is associated with each other by applying the correlation rule to each of the logs, and stores the scenario candidates to the storage module along with an importance degree of the scenario candidate given by the correlation rule; a scenario candidate evaluation unit which recalculates the importance degree for each of the scenario candidates; and a result display unit which displays/outputs the scenario candidate with the recalculated high importance degree, wherein the scenario candidate evaluation unit includes: a user association degree evaluation function which enumerates possible users who may have done each of the operations contained in each of the scenario candidates, and calculates user association degrees that are relevancies of each of the users for each of the operations; an operation association degree evaluation function which calculates operation association degrees that are relevancies between each of the operations of each of the scenario candidates; and a scenario candidate importance degree reevaluation function which recalculates the importance degrees of each of the scenario candidates by each of the users according to the user association degrees and the operation association degrees.

### (Supplementary Note 2)

The security event monitoring device as depicted in Supplementary Note 1, wherein the user association degree evaluation function enumerates the users capable of conducting an operation for the monitoring target device at a time where the operations contained in each of the scenario candidates are conducted.

### (Supplementary Note 3)

The security event monitoring device as depicted in Supplementary Note 1, wherein the user association degree evaluation function enumerates the users authorized to conduct the operations contained in each of the scenario candidates by making an inquiry to a directory service device connected externally.

### (Supplementary Note 4)

The security event monitoring device as depicted in Supplementary Note 1, wherein the operation association degree evaluation function calculates the operation association degrees from a similarity between files to be the targets of each of the operations based on an evaluation standard given in advance.

### (Supplementary Note 5)

The security event monitoring device as depicted in Supplementary Note 4, wherein the operation association degree evaluation function uses at least one selected from names, sizes, pass names, hash values, and electronic signatures of files as the targets of each of the operations as the evaluation standard of the similarity between the files.

### (Supplementary Note 6)

The security event monitoring device as depicted in Supplementary Note 1, wherein the scenario candidate importance degree reevaluation function recalculates the importance degrees of each of the scenario candidates of each of the users by integrating a total value of products of the user association degrees of the each of the users corresponding to the scenario candidate and the importance degrees of each of the operations contained in each of the scenario candidates with a total value of products of the operation association degrees between each of the operations contained in each of the scenario candidates, the importance degrees of the operations, and the importance degrees of each of the scenario candidates.

### (Supplementary Note 7)

The security event monitoring device as depicted in Supplementary Note 1, wherein the result display unit displays the scenario candidate of the high importance together with the user of the high association degree for the scenario candidate.

### (Supplementary Note 8)

A security event monitoring method used for a security event monitoring device which detects a specific operation from logs that are records of operations conducted on a plurality of monitoring target devices connected mutually on a same local network, wherein: a log collection unit receives each of the logs from each of the monitoring target devices; a correlation analysis unit which generates scenario candidates in which each of the logs is associated with each other by applying a correlation rule to each of the logs; the correlation analysis unit stores each of the scenario candidates to the storage module along with importance degrees of the scenario candidates given by the correlation rule; a user association degree evaluation function of a scenario candidate evaluation unit enumerates possible users who may have done each of the operations contained in each of the scenario candidates; the user association degree evaluation function calculates the user association degrees that are relevancies of each of the users for each of the operations; an operation association degree evaluation function of the scenario candidate evaluation unit calculates operation association degrees that are relevancies between each of the operations of each of the scenario candidates; a scenario candidate importance degree recalculation function of the scenario candidate evaluation unit recalculates the importance degrees of each of the scenario candidates by each of the users according to the user association degrees and the operation association degrees; and a result display unit displays/outputs the scenario candidate of the high importance degree.

### (Supplementary Note 9)

A non-transitory computer readable recording medium storing a security event monitoring program used in a security event monitoring device which detects a specific operation from logs that are records of operations conducted on a plurality of monitoring target devices connected mutually on a same local network, and the program causes a computer provided to the security event monitoring device to execute: a procedure for receiving each of the logs from each of the monitoring target devices; a procedure for generating scenario candidates in which each of the logs are associated by applying a correlation rule given in advance to each of the logs; a procedure for storing each of the scenario candidates along with the importance degrees of the scenario candidates given by the correlation rule; a procedure for enumerating possible users who may have done each of the operations contained in each of the scenario candidates; a procedure for calculating user association degrees that are relevancies of each of the users for each of the operations; a procedure for calculating operation association degrees that are relevancies between each of the operations of each of the scenario candidates; a procedure for recalculating importance degrees of each of the scenario candidates by each of the users according to the user association degrees and the operation association degrees; and a procedure for displaying/outputting the scenario candidate of the high importance degree.

The present invention can be applied to a computer network. In particular, the present invention is suited for the use for decreasing the risk of leaking the information in the network which handles a vast amount of confidential information and personal information.

What is claimed is:

1. A security event monitoring device which detects a specific operation from logs that are records of operations conducted on a plurality of monitoring target devices connected mutually on a same local network, the security event monitoring device comprising:
a storage module which stores in advance a correlation rule that is applied when performing a correlation analysis on each of the logs:
a log collection unit which receives each of the logs from each of the monitoring target devices;
a correlation analysis unit which generates scenario candidates in which each of the logs is associated with each other by applying the correlation rule to each of the logs, and stores the scenario candidates to the storage module along with an importance degree of the scenario candidate given by the correlation rule;
a scenario candidate evaluation unit which recalculates the importance degree for each of the scenario candidates; and
a result display unit which displays/outputs the scenario candidate with the recalculated high importance degree, wherein
the scenario candidate evaluation unit comprises:
a user association degree evaluation function which enumerates possible users who may have done each of the operations contained in each of the scenario candidates, and calculates user association degrees that are relevancies of each of the users for each of the operations;
an operation association degree evaluation function which calculates operation association degrees that are relevancies between each of the operations of each of the scenario candidates; and
a scenario candidate importance degree reevaluation function which recalculates the importance degrees of each of the scenario candidates by each of the users according to the user association degrees and the operation association degrees.

2. The security event monitoring device as claimed in claim 1, wherein
the user association degree evaluation function enumerates the users capable of conducting an operation for the monitoring target device at a time where the operations contained in each of the scenario candidates are conducted.

3. The security event monitoring device as claimed in claim 1, wherein
the user association degree evaluation function enumerates the users authorized to conduct the operations contained in each of the scenario candidates by making an inquiry to a directory service device connected externally.

4. The security event monitoring device as claimed in claim 1, wherein
the operation association degree evaluation function calculates the operation association degrees from a similarity between files to be the targets of each of the operations based on an evaluation standard given in advance.

5. The security event monitoring device as claimed in claim 4, wherein
the operation association degree evaluation function uses at least one selected from names, sizes, pass names, hash values, and electronic signatures of files as the targets of each of the operations as the evaluation standard of the similarity between the files.

6. The security event monitoring device as claimed in claim 1, wherein
the scenario candidate importance degree reevaluation function recalculates the importance degrees of each of the scenario candidates of each of the users by integrating a total value of products of the user association degrees of the each of the users corresponding to the scenario candidate and the importance degrees of each of the operations contained in each of the scenario candidates with a total value of products of the operation association degrees between each of the operations contained in each of the scenario candidates, the importance degrees of the operations, and the importance degrees of each of the scenario candidates.

7. The security event monitoring device as claimed in claim 1, wherein
the result display unit displays the scenario candidate of the high importance together with the user of the high association degree for the scenario candidate.

8. A security event monitoring method used for a security event monitoring device which detects a specific operation from logs that are records of operations conducted on a plurality of monitoring target devices connected mutually on a same local network, wherein:
a log collection unit receives each of the logs from each of the monitoring target devices;
a correlation analysis unit which generates scenario candidates in which each of the logs is associated with each other by applying a correlation rule to each of the logs;
the correlation analysis unit stores each of the scenario candidates to the storage module along with importance degrees of the scenario candidates given by the correlation rule;
a user association degree evaluation function of a scenario candidate evaluation unit enumerates possible users who may have done each of the operations contained in each of the scenario candidates;
the user association degree evaluation function calculates the user association degrees that are relevancies of each of the users for each of the operations;
an operation association degree evaluation function of the scenario candidate evaluation unit calculates operation association degrees that are relevancies between each of the operations of each of the scenario candidates;
a scenario candidate importance degree recalculation function of the scenario candidate evaluation unit recalculates the importance degrees of each of the scenario candidates by each of the users according to the user association degrees and the operation association degrees; and
a result display unit displays/outputs the scenario candidate of the high importance degree.

9. A non-transitory computer readable recording medium storing a security event monitoring program used in a security event monitoring device which detects a specific operation from logs that are records of operations conducted on a plurality of monitoring target devices connected mutually on a same local network, the program causing a computer provided to the security event monitoring device to execute:
a procedure for receiving each of the logs from each of the monitoring target devices;
a procedure for generating scenario candidates in which each of the logs are associated by applying a correlation rule given in advance to each of the logs;
a procedure for storing each of the scenario candidates along with the importance degrees of the scenario candidates given by the correlation rule;
a procedure for enumerating possible users who may have done each of the operations contained in each of the scenario candidates;
a procedure for calculating user association degrees that are relevancies of each of the users for each of the operations;
a procedure for calculating operation association degrees that are relevancies between each of the operations of each of the scenario candidates;
a procedure for recalculating importance degrees of each of the scenario candidates by each of the users according to the user association degrees and the operation association degrees; and
a procedure for displaying/outputting the scenario candidate of the high importance degree.

10. A security event monitoring device which detects a specific operation from logs that are records of operations conducted on a plurality of monitoring target devices connected mutually on a same local network, the security event monitoring device comprising:
storage means for storing in advance a correlation rule that is applied when performing a correlation analysis on each of the logs:
log collection means for receiving each of the logs from each of the monitoring target devices;
correlation analysis means for generating scenario candidates in which each of the logs is associated with each other by applying the correlation rule to each of the logs, and storing the scenario candidates to the storage means along with an importance degree of the scenario candidate given by the correlation rule;
scenario candidate evaluation means for recalculating the importance degree for each of the scenario candidates; and
result display means for displaying/outputting the scenario candidate with the recalculated high importance degree, wherein
the scenario candidate evaluation means comprises:
a user association degree evaluation function which enumerates possible users who may have done each of the operations contained in each of the scenario candidates, and calculates user association degrees that are relevancies of each of the users for each of the operations;
an operation association degree evaluation function which calculates operation association degrees that are relevancies between each of the operations of each of the scenario candidates; and
a scenario candidate importance degree reevaluation function which recalculates the importance degrees of each of the scenario candidates by each of the users according to the user association degrees and the operation association degrees.
